(19) United States
(12) Patent Application Publication
(10) Pub. No.: US 2010/0007985 A1
(43) Pub. Date: Jan. 14, 2010

(54) METHOD FOR PRODUCING MAGNETIC MEDIUM, MAGNETIC RECORD REPRODUCTION DEVICE, AND MAGNETIC RECORDING MEDIUM

(75) Inventors: Masato FUKUSHIMA, Chiba-shi (JP); Akira Sakawaki, Ichihara-shi (JP)

Correspondence Address: SUGHRUE MION, PLLC, 2100 PENNSYLVANIA AVENUE, N.W., SUITE 800, WASHINGTON, DC, 20037, US

(73) Assignee: SHOWA DENKO K. K., Tokyo (JP)

(21) Appl. No.: 12/498,685

(22) Filed: Jul. 7, 2009

(30) Foreign Application Priority Data
Jul. 10, 2008 (JP) P2008-180695

(51) Int. Cl. G11B 5/596; B32B 37/02

(52) U.S. Cl. 360/77.02; 156/272.6

(57) ABSTRACT

One object of the present invention is to provide a method for producing a magnetic recording medium which has excellent magnetic separation properties of the magnetic recording pattern, the present invention providing a method for producing a magnetic recording medium having a magnetic recording pattern which is magnetically separated, comprising the steps of: after laminating at least a magnetic layer and a carbon protective layer on a non-magnetic substrate in this order, partially irradiating with a reactive plasma containing carbon and a halogen or reactive ions which are generated in the reactive plasma on a surface of the carbon protective layer, and thereby forming a halogenated carbon protective layer, which is obtained by partially halogenating the carbon protective layer, and the magnetic recording pattern separated magnetically which is obtained by partially improving the magnetic layer.

### CROSS-REFERENCE TO RELATED APPLICATION

Priority is claimed on Japanese Patent Application, No. 2008-180695, filed on Jul. 10, 2008, the contents of which are incorporated herein by reference in their entirety.

### BACKGROUND OF THE INVENTION

1. Field of the Invention

The present invention relates to a method for producing a magnetic recording medium, which is used in a hard disc device (HDD) and the like, a magnetic recording and reproducing device, and a magnetic recording medium.

2. Description of the Related Art

In recent years, magnetic recording devices, such as magnetic disk drives, flexible disk drives, and magnetic tape drives, have greatly expanded their ranges of application and importance. At the same time, the recording density of the magnetic recording media used in these devices has increased remarkably. Particularly, the areal recording density has further increased since the Magneto Resistive head and the Partial Response Maximum Likelihood technique were introduced. Due to the further introduction of the Giant-Magneto Resistive head and the Tunneling Magnet Resistive head in recent years, the increase is continuing at a pace of about 100% per year.

These magnetic recording media are still required to attain a much higher recording density in the future. Therefore, the magnetic recording layers are required to have a high coercive force, Signal-to-Noise Ratio (SNR), and resolution. In recent years, efforts to increase the track density have been made together with efforts to increase linear recording density.

In the latest magnetic recording devices, the track density has reached 110 kTPI. As the track density is further increased, it tends to cause problems in which information magnetically recorded in adjacent tracks interferes with each other and this causes the magnetization transition region in the borderline region to become a noise source and impair the SNR. This hinders the enhancement of the recording density because it immediately results in lowering of the bit error rate.

In order to increase the areal recording density, it is necessary to minimize the size of an individual recording bit in the magnetic recording medium as much as possible and maintain a large saturated magnetization and a magnetic film thickness as much as possible in the individual recording bit. When the size of the recording bit further becomes smaller, however, the minimum volume of magnetization per bit also becomes smaller. Consequently, problems are caused in which magnetization reversal is caused by thermal fluctuation, and recorded data is lost.

Furthermore, when the track density is increased, the track pitch becomes small. Therefore, the magnetic recording device requires a track servo technique with an extremely high accuracy. On the other hand, a method in which recording is executed in a large width, and reproducing is executed in a smaller width than the recording to eliminate the influences due to adjacent tracks as much as possible has been used. This method can minimize the influences due to adjacent tracks. However, it is difficult to obtain sufficient reproduced output by this method. As a result, it is difficult to maintain a sufficient SNR.

As one method for solving the problems caused by thermal fluctuation, maintaining a sufficient SNR, and a sufficient output, attempts to enhance the track density by forming irregularities along the tracks on the surface of the recording medium and consequently physically separating mutually the adjacent tracks have been continuously made. This technique is called “a discrete track method” and the magnetic recording media that are produced by this technique are called “discrete track media”. Furthermore, attempts to produce so-called patterned media of which a data region in one track is further divided have also been made.

As one example of the discrete track media, a magnetic recording medium, in which a magnetic recording medium is formed on a non-magnetic substrate having a surface with irregular patterns to obtain magnetic recording tracks and servo signal patterns which are physically separated, is known (for example, Patent Document No. 1).

In this magnetic recording medium, a ferromagnetic layer is formed on the surface having some irregularities of a substrate, via a soft magnetic layer, and a protective film is formed on the surface of the ferromagnetic layer. In this magnetic recording medium, magnetic recording regions are formed in the convex regions which are magnetically divided from the surrounding area.

It is believed that this magnetic recording medium is a high-density magnetic recording medium having less noise, because it can prevent the generation of magnetic domain walls in the soft magnetic layer, suppress adverse influences due to the thermal fluctuation, and it does not cause interference between adjacent signals.

The discrete track method is classified into two methods. One of them is a method in which tracks are formed after formation of a magnetic recording medium including several thin films. The other is a method in which thin films for a magnetic recording medium are formed after direct formation of the irregular patterns at the surface of a substrate, or in a thin film layer for making tracks (for example, Patent Documents Nos. 2 and 3).

The former method is called “a magnetic layer processing-type method”. This magnetic layer processing-type method has disadvantages in which the medium is easily contaminated during the production and the production processes are greatly complicated, because it requires a physical process to be carried out on the surface of the magnetic recording medium after production. The latter method is called “an emboss processing-type method”. This emboss processing-type method does not readily contaminate the medium during the production. However, this has disadvantages in which the floating position and the floating height of the recording and reproducing head above the medium are not stable while recording and reproducing, because the irregular shape formed on the substrate causes the irregular shape in a film which is formed on the substrate having an irregular surface.

In addition, a method for transforming partially magnetic properties in regions intervening between magnetic tracks of a discrete track medium by injecting nitrogen ions or oxygen ions or radiating a laser into a preformed magnetic layer has also been disclosed (Patent Documents Nos. 4 to 6).

However, the magnetic layer is damaged by the ion injection or the laser radiation, and irregularities may be formed at the surface of the magnetic layer in this method. In addition, the energy level of the ions injected or the laser is high, but the energy density per entire surface of the media is small. Therefore, this method requires a long treatment time to transform magnetic properties of the entire surface of the medium.

[Patent Document No. 1] Japanese Unexamined Patent Application, First Publication No. 2004-164692

[Patent Document No. 2] Japanese Unexamined Patent Application, First Publication No. 2004-178793

[Patent Document No. 3] Japanese Unexamined Patent Application, First Publication No. 2004-178794

[Patent Document No. 4] Japanese Unexamined Patent Application, First Publication No. Hei 5-205257

[Patent Document No. 5] Japanese Unexamined Patent Application, First Publication No. 2006-209952

[Patent Document No. 6] Japanese Unexamined Patent Application, First Publication No. 2006-309841

### SUMMARY OF THE INVENTION

In order to solve the problems, the present inventors have already suggested a method for producing a magnetic recording medium having a magnetically separated magnetic recording pattern, the method comprising: after forming a magnetic layer on a non-magnetic substrate, irradiating partially a reactive plasma or reactive ions which are generated in the plasma on a surface of the magnetic layer, thereby magnetic properties at the irradiated portion are improved, and a magnetic recording pattern, which is magnetically separated, is formed (Japanese Patent Application No. 2007-161581).

This production method does not physically mill the magnetic layer by ion milling when forming the magnetic recording pattern, which is magnetically separated, in the magnetic layer, dissimilar to conventional production methods. Therefore, less dust is generated during a separation method. In addition, the separation of the magnetic layer can be carried out with high efficiency.

However, after forming the magnetic layer, a resist pattern is formed on the surface of the magnetic layer, and the magnetic layer is divided using the resist pattern in this method. Therefore, it is necessary to prevent contamination of the surface of the magnetic layer due to the resist, and the like.

In order to solve the problem, a method has been made in which after the surface of the magnetic layer is covered with a carbon protective layer, a resist pattern is formed on the surface of the carbon protective layer, and reactive ions and the like are applied to the magnetic layer through the carbon protective layer.

However, this method may damage the carbon protective layer by the reactive ions, and the damaged carbon protective layer may not work as a protective layer.

The protective layer in the magnetic recording medium is required to prevent the magnetic layer, etc. from being corroded by environmental materials, protect the magnetic layer, etc. when a magnetic head accidentally contacts the magnetic recording medium, or improve wettability between a lubricant coated at the surface of the magnetic recording medium and the magnetic recording medium.

The present invention has been suggested to solve the problems. One object of the present invention is to provide a method for producing a magnetic recording medium which has a magnetic layer containing less contamination, has excellent magnetic separation properties of the magnetic recording pattern, less influence of signals between adjacent magnetic recording patterns, and can provide a magnetic recording medium having a high recording density with a high productivity.

Another object of the present invention is to provide a magnetic recording and reproducing device using the magnetic recording medium produced by the production method.

Another object of the present invention is to provide a magnetic recording medium produced by the production method.

In order to achieve the objects, the present invention provides the following:

(1) A method for producing a magnetic recording medium having a magnetic recording pattern which is magnetically separated, comprising the steps of: after laminating at least a magnetic layer and a carbon protective layer on a non-magnetic substrate in this order, partially irradiating with a reactive plasma containing carbon and a halogen or reactive ions which are generated in the reactive plasma on a surface of the carbon protective layer, and thereby forming a halogenated carbon protective layer, which is obtained by partially halogenating the carbon protective layer, and the magnetic recording pattern magnetically separated which is obtained by partially improving the magnetic layer
(2) The method for producing a magnetic recording medium according to (1), wherein a magnetization amount of an improved part of the magnetic layer is 75% or less relative to a magnetization amount of the magnetic layer before improvement.
(3) The method for producing a magnetic recording medium according to (1) or (2), wherein the reactive ions contain carbon and a halogen ion which are obtained by introducing at least one halogenated gas selected from the group of CF₄, CF₆, CHF₃, and CCl₄, into the reactive plasma.
(4) The method for producing a magnetic recording medium according to (3), wherein the halogen ion is at least one of CF³⁺, CF²⁺, and F⁻.
(5) The method for producing a magnetic recording medium according to any one of (1) to (4), wherein after forming the carbon protective layer, a mask layer is further formed on the carbon protective layer, and the carbon protective layer, where the mask layer is not formed, is partially irradiated with the reactive plasma including carbon and a halogen or the reactive ions which are generated in the reactive plasma.
(6) The method for producing a magnetic recording medium according to any one of (1) to (5), wherein the magnetic recording pattern is a perpendicular magnetic recording pattern.
(7) A magnetic recording and reproducing device comprising:

the magnetic recording medium produced by the production method according to any one of (1) to (6);

a driving part for driving the magnetic recording medium in a recording direction;

a magnetic head for recording and reproducing the magnetic recording medium;

a head shifting device for relatively shifting the magnetic head to the magnetic recording medium; and

a recording and reproducing signal processing device for inputting a signal to the magnetic head and reproducing an output signal from the magnetic head.

(8) A magnetic recording medium comprising a magnetic layer and a carbon protective layer on a non-magnetic substrate in this order, a halogenated carbon protective layer which is obtained by halogenating partially the carbon protective layer, and a magnetic recording pattern which is obtained by partially improving the magnetic layer to be magnetically separated.
(9) The magnetic recording medium according to (8), wherein the halogenated carbon protective layer and the improved magnetic layer are continuously formed in a thickness direction thereof.

As explained above, according to the present invention, after laminating at least a magnetic layer and a carbon protective layer on a non-magnetic substrate in this order, a surface of the magnetic layer, on which the carbon protective layer is formed, is irradiated with a reactive plasma containing carbon and a halogen. Otherwise, a surface of the magnetic layer, on which the carbon protective layer is formed, is partially irradiated with reactive ions which are generated in the reactive plasma. Thereby, a halogenated carbon protective layer is obtained by partially halogenating the carbon protective layer. At the same time, the magnetic layer is partially improved to form a magnetic recording pattern which is magnetically separated. Therefore, it is possible to produce a magnetic recording medium with high productivity, which has a magnetic layer containing less contamination, has excellent magnetic separation properties of the magnetic recording pattern, less influence of signals between adjacent magnetic recording patterns, and can provide a magnetic recording medium having a high recording density.

In addition, the magnetic recording medium produced by the production method according to the present invention has high corrosion resistance to environmental materials, a high coverage of a lubricant, and high resistance to accidental contact with the magnetic head.

### BRIEF DESCRIPTION OF THE DRAWINGS

FIG. 1 is a cross-sectional view showing one example of a magnetic recording medium which is produced by the production method according to the present invention.

FIG. 2 is a cross-sectional view showing one example of a magnetic recording and reproducing device.

FIG. 3 is a schematic view showing the production method according to the present invention.

### DETAILED DESCRIPTION OF THE INVENTION

The present invention will be explained in detail referring to Figures. Moreover, in order to illustrate the features, characteristic parts may be enlarged for convenience sake. The scale size of each component may be different from the actual size.

### (Production Method for a Magnetic Recording Medium)

The method for producing a magnetic recording medium according to the present invention is a method for producing a magnetic recording medium having a magnetic recording pattern which is magnetically separated, comprising the steps of: after laminating at least a magnetic layer and a carbon protective layer on a non-magnetic substrate in this order, partially irradiating with a reactive plasma containing carbon and a halogen or reactive ions which are generated in the reactive plasma on a surface of the carbon protective layer, and thereby forming a halogenated carbon protective layer, which is obtained by partially halogenating the carbon protective layer, and the magnetic recording pattern magnetically separated which is obtained by partially improving the magnetic layer

In the production method according to the present invention, when forming the magnetic recording pattern, the magnetic layer is not physically milled by ion milling, dissimilar to conventional production methods. In a separation step for magnetically separating the magnetic layer, dust is not generated. In addition, the production method according to the present invention does not have a step which damages the magnetic layer, such as a step of injecting ions into the magnetic layer.

In addition, when the carbon protective layer has damage due to irradiation of a reactive plasma, the carbon protective layer is halogenated, and carbon contained in the plasma repairs the damage to the carbon protective layer. Therefore, it is possible to maintain or improve the properties of the carbon protective layer.

The inventors of the present invention have already confirmed by experiments that it is possible to react the magnetic layer and the reactive plasma after forming the carbon protective layer on the surface of the magnetic layer. The inventors believe that the reasons for enabling the reaction between the magnetic layer which is covered with the carbon protective layer and the reactive plasma are that: there are voids in the carbon protective layer, and the reactive ions in the reactive plasma enter through the voids, and the reactive ions react with a magnetic metal. In addition, it is also believed that the reactive ions are dispersed into the carbon protective layer, and the dispersed reactive ions reach the magnetic layer. At this time, the carbon protective layer may be slightly damaged. However, since the reactive plasma containing carbon and a halogen is used in the present invention, the carbon protective layer is halogenated. In addition, the damage to the carbon protective layer is repaired by carbon contained in the reactive plasma. Due to this, it is possible to maintain or improve the properties of the carbon protective layer in the present invention. In addition, the inventors of the present invention believe that since the halogenated carbon protective layer has high lubricating ability, and high wettability to lubricants, the halogenated carbon protective layer has high performance as a protective layer in a magnetic recording medium.

In the present invention, an improvement of the magnetic layer means a change of magnetic properties of the magnetic layer, such as coercive force, and remnant magnetization. The change denotes lowering of the coercive force and the remnant magnetization. In particular, it is preferable that the magnetization in an improved part of the magnetic layer be 75% or less of the magnetization of the magnetic layer before improvement, and more preferably 50% or less. In addition, it is also preferable that the coercive force in an improved part of the magnetic layer be 50% or less of the coercive force of the magnetic layer before improvement, and more preferably 20% or less.

Examples of the reactive plasma include Inductively Coupled Plasma (ICP) and Reactive Ion Plasma (RIE).

The ICP is a plasma at high temperature which is obtained by energizing gas with high voltage to make plasma, and generating Jule heat due to eddy current inside of the plasma by a variable magnetic field with high frequencies. The ICP has high electron density. Compared with conventional ion beams which have been used to produce discrete track media, it is possible to improve magnetic properties with high efficiency in a magnetic film having a larger area.

For the reactive ions, reactive gases which contain carbon and a halogen ion which are obtained by introducing at least one of halogenated gas selected from the group CF₄, CF₆, CHF₃, and CCl₄, into the reactive plasma can be used. Examples of the halogenated ions include CF³⁺, CF²⁺, and F⁻. These halogenated ions can be used alone or in combination thereof.

In the present invention, the carbon protective layer is halogenated with high efficiency by using the reactive plasma including the reactive gas. At the same time, it is possible to maintain or improve the properties of the carbon protective layer due to carbon contained in the reactive plasma to repair the damage to the carbon protective layer.

In the present invention, the improvement of the magnetic layer means partial amorphization of the magnetic layer by irradiating the reactive plasma, etc. That is, the improvement of the magnetic layer also means conversion of the crystal structure in the magnetic layer. Specifically, the amorphization of the magnetic layer means making an atomic arrangement in the magnetic layer irregular without regularity in a long distance. More specifically, it means making the atomic arrangement in the magnetic layer be in a condition in which fine crystal particles having a particle size of less than 2 nm are arranged randomly. When the atomic arrangement of the magnetic layer is confirmed by analysis, the magnetic layer is put into a condition in which a peak showing a crystal plane is not confirmed, and only a halo is confirmed by X-ray analysis or electron analysis.

It preferable that the improvement of the magnetic layer be achieved by a reaction between a magnetic metal constituting the magnetic layer and an atom or an ion in the reactive plasma. Specifically, when the magnetic layer is improved, the atom or the ion in the reactive plasma enters into the magnetic metal. Thereby, the crystal structure in the magnetic metal changes, the composition of the magnetic metal changes, or the magnetic metal is oxidized, nitrided, or silicated.

It is preferable in the production method for a magnetic recording medium according to the present invention that after the formation of the carbon protective layer, a mask layer be formed on the carbon protective layer, and the carbon protective layer where the mask does not cover be irradiated partially with the reactive plasma containing carbon and a halogen or reactive ions which are generated in the reactive plasma.

Specifically, after the formation of a resist pattern which corresponds to the magnetic recording pattern on the surface of the carbon protective layer, the surface of the resist pattern is treated with the reactive plasma, and then the resist is removed. Thereby, it is possible to enhance the reactivity between the magnetic layer and the reactive plasma. Moreover, it is also possible to form the carbon protective layer again after removing the resist.

In order to form the resist pattern, it is possible to apply the resist on the carbon protective layer, close contacting directly a stamp on the resist, and pressing them to each other with high pressure. In addition, it is also possible to use a conventional photolithography technique to make the pattern. Examples of the resist include thermosetting resins, UV hardening resins, SOGs.

The stamp may have fine track patterns obtained by drawing the pattern in a metal plate with an electron beam. Any material can be used in the stamp as long as it has sufficient hardness and durability to be used in the process. For example, Ni, and the like can be used. In general, servo signal patterns, such as burst patterns, grey code patterns, preamble patterns, can be formed in the stamp, in addition to the tracks which are recorded with common data. The removal of the resist after the treatment with the reactive plasma can be carried out by dry etching, reactive ion etching, ion milling, wet etching, etc.

As explained above, according to the production method for a magnetic recording medium, it is not necessary to form the protective layer after the treatment with the reactive plasma. The production processes are simple. Therefore, productivity can be improved, and contamination during the production of a magnetic recording medium can be decreased. Consequently, according to the present invention, it is possible to produce a magnetic recording medium which has a magnetic layer containing less contamination, has excellent magnetic separation properties of the magnetic recording pattern, less influence of signals between adjacent magnetic recording patterns, and can provide a magnetic recording medium having a high recording density with high productivity.

### (Magnetic Recording Medium)

The magnetic recording medium according to the present invention comprises a magnetic layer and a carbon protective layer on a non-magnetic substrate in this order, a halogenated carbon protective layer, which is obtained by halogenating partially the carbon protective layer, and a magnetic recording pattern which is obtained by improving partially the magnetic layer to be separated magnetically.

The magnetic recording medium of the present invention may be various magnetic recording media having a magnetic recording pattern which is separated magnetically. Examples of the magnetic recording medium having a magnetic recording pattern include so-called patterned media, in which a magnetic recording pattern is regularly arranged in each bit, media in which the magnetic recording pattern having the same shape of as that of track, and media in which the recording pattern is the servo signal pattern. Among these, so-called discrete type magnetic recording media, in which the magnetic recording pattern magnetically separated is a magnetic recording track or a servo signal pattern, are preferable, because the production method is simple.

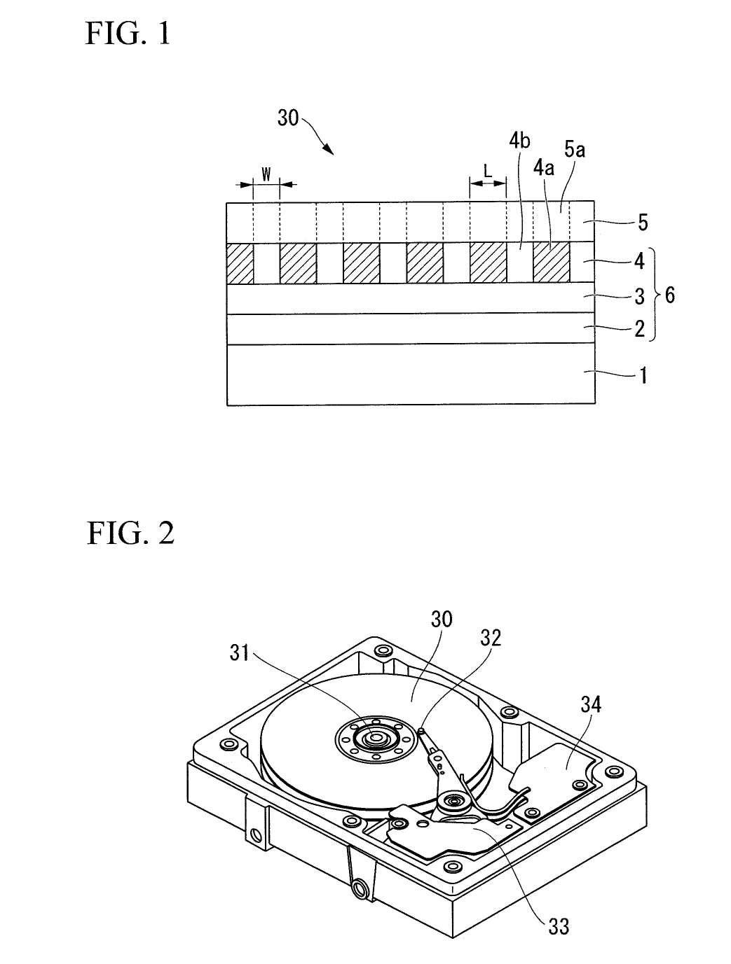

The magnetic recording medium of the present invention is explained in detail referring to a discrete type magnetic recording medium 30 shown in FIG. 1.

As shown in FIG. 1, the magnetic recording medium 30 includes a soft magnetic layer 2, an intermediate layer 3, a recording magnetic layer 4 having magnetic patterns 4b which are magnetically separated by a non-magnetic layer 4a, and a carbon protective layer 5, layered on a non-magnetic substrate 1 in this order. In addition, a lubricant film, which is not shown in FIG. 1, is further formed on the outermost surface of the layered product. The soft magnetic layer 2, the intermediate layer 3, and the recording magnetic layer 4 constitute a magnetic layer 6. The carbon protective layer 5 includes a halogenated carbon protective layer 5a, which is obtained by partially halogenating the carbon protective layer 5. The halogenated carbon protective layer 5a and the non-magnetic layer 4a are continuously formed in the thickness direction thereof.

In the magnetic recording medium 30, it is preferable that the width W of magnetic regions in the recording magnetic layer 4 (the width W of the magnetic pattern 4b), be 200 nm, and the width L of the non-magnetic region (the width L of the non-magnetic layer 4a) be 100 nm, in order to improve the recording density. It is also preferable that the track pitch P (W+L) be as narrow as possible, in order to improve the recording density. Specifically, it is preferably 300 nm or less.

Examples of the non-magnetic substrate 1 include Al alloy substrates containing Al as a main component, such as Al—Mg alloy substrates; glass substrates, such as common soda glass substrates, aluminosilicate glass substrates, crystallized glass substrates; silicon substrates; titanium substrates; ceramics substrates; and resin substrates. Any non-magnetic substrate can be used. Among these, Al alloy substrates, glass substrates such as crystallized glass substrates, and silicon substrates are preferably used. The average surface roughness of the substrate is preferably 1 nm or less, more preferably 0.5 nm, and most preferably 0.1 nm or less.

The magnetic layer 6 may be an in-plane magnetic layer used in in-plane magnetic recording media or a perpendicular magnetic layer used in perpendicular magnetic media. In order to achieve higher recording density, the perpendicular magnetic layer is preferable. In addition, the magnetic layer 6 is preferably made of an alloy containing Co as a main component.

For the magnetic layer 6 used in the perpendicular magnetic recording medium, a laminate including the soft magnetic layer 2 made of a FeCo alloy, such as FeCoB, FeCoSiB, FeCoZr, FeCoZrB, and FeCoZrBCu; a FeTa alloy, such as FeTaN, and FeTaC; a Co alloy, such as CoTaZr, CoZrNB, and CoB, the intermediate layer 3 made of Ru, etc., and the recording magnetic layer 4 made of a 70Co-15Cr-15Pt alloy or a 70Co-5Cr-15Pt-10SiO₂ alloy can be used. An orientation controlling film made of Pt, Pd, NiCr, or NiFeCr may be formed between the soft magnetic layer 2 and the intermediate layer 3.

For the magnetic layer 6 used in the in-plane magnetic recording media, a laminate including a non-magnetic underlying layer made of CrMo and a ferromagnetic layer made of CoCrPtTa can be used.

The thickness of the recording magnetic layer 4 is preferably in a range of from 3 nm or 20 nm, and more preferably in a range of from 5 nm to 15 nm. In this range, the thickness of the recording magnetic layer 4 can be selected depending on the kind of magnetic alloy used and the laminate structure, to obtain sufficient head output. Moreover, the recording magnetic layer 4 is required to have a thickness which can achieve a certain output or more while reproducing. However, several parameters showing recording and reproducing properties are generally degraded when output is increased. Therefore, it is necessary to adjust the thickness of the recording magnetic layer 4. The recording magnetic layer 4 is generally obtained as a thin film made by sputtering.

In general, the carbon protective layer 5 can be obtained by forming a DLC (Diamond-Like Carbon) film by P-CVD. However, the carbon protective layer 5 used in the present invention is not limited to this. In other words, the carbon protective layer 5 can be made of materials containing carbon, which is generally used as a material constituting the protective layer, such as carbon (C), hydrogenated carbon (H×C), nitride carbon (CN), amorphous carbon, and silicon carbide. The carbon protective layer 5 may include two or more layers. It is necessary for the thickness of the carbon protective layer 5 to be 10 nm or less. When it exceeds 10 nm, the distance between the magnetic head and the magnetic layer 6 is large, sufficient signal strength while outputting or inputting may not be obtained.

It is preferable that a lubricant film be formed by applying a lubricant on the carbon protective layer 5. Examples of the lubricant include fluorine lubricants, carbon hydride lubricants, and a mixture thereof. In general, the lubricant is applied in a thickness in a range of from 1 to 4 nm to form the lubricant film.

In the magnetic recording medium 30, a mask layer is formed on the surface of the carbon protective layer 5, and the carbon protective layer 5, on which the mask is not formed, is irradiated partially with a reactive plasma containing carbon and a halogen or reactive ions which are generated in the reactive plasma, by the production method according to the present invention. Thereby, the halogenated carbon protective layer 5a, which is obtained by halogenating partially the carbon protective layer 5, and the non-magnetic layer 4a, which is obtained by partially improving the recording magnetic layer 4 through the halogenated carbon protective layer 5a, are continuously formed in the thickness direction thereof.

Because of having such a structure, the magnetic recording medium 30 of the present invention has high corrosion resistance to environmental materials, a high coverage of a lubricant, and high resistance to accidental contact with the magnetic head.

### (Magnetic Recording and Reproducing Device)

One embodiment of the magnetic recording and reproducing device (HDD) according to the present invention is explained referring to FIG. 2.

As shown in FIG. 2, the magnetic recording and reproducing device includes the magnetic recording medium 30 of the present invention; a revolution drive 31 for rotationally driving the magnetic recording medium 30 (a driving part for driving the magnetic recording medium in a recording direction); a magnetic head 32 for recording and reproducing the magnetic recording medium 30; a head shifting device 33 for relatively shifting the magnetic head 32 to the magnetic recording medium 30 in a radial direction of the magnetic recording medium 30 (a head shifting device for relatively shifting the magnetic head to the magnetic recording medium); and a recording and reproducing signal processing device 34 (a recording and reproducing signal processing means) for inputting a signal to the magnetic head 32 and reproducing an output signal from the magnetic head 32.

In this magnetic recording and reproducing device, it is possible to eliminate blurring during the magnetic recording in the magnetic recording medium 30, and obtain a high areal recording density by using the magnetic recording medium 30 of the discrete track type. That is, it is possible to produce a magnetic recording and reproducing device having a high recording density using the magnetic recording medium 30 of the present invention.

In addition, in order to exclude the influence of the magnetic transition regions of the track edge part, the width of the reproducing head is adjusted to be narrower than the width of the recording head in conventional magnetic recording reproducing devices. However, in contrast, according to the magnetic recording and reproducing device, since the recording track is magnetically divided in the magnetic recording medium 30, it is possible to adjust the width of the reproducing head to be substantially equal to the width of the recording head. Thereby, a sufficient reproduced output and high SNR can be obtained.

In addition, when the reproducing part of the magnetic head 32 is a GMR head or a TMR head, sufficient signal strength can be obtained during high recording density. As a result, it is possible to produce a magnetic recording and reproducing device with a high recording density.

When the floating height of the magnetic head is adjusted to a range of from 0.005 μm to 0.020 μm, which is lower than conventional floating height, the output is increased, and high SNR can be obtained. As a result, magnetic recording and a reproducing device having a higher capacity and higher reliability can be produced.

Furthermore, when the signal processing circuit using the maximum likelihood decoding method is combined, the areal recording density can be further improved. Specifically, when recording and reproducing are carried out under conditions in which the track density is 100 k tracks/inch or more, the linear recording density is 1000 k bits/inch or more, and the recording density per square inch is 100 G bits or more, sufficient SNR can be obtained.

### EXAMPLES

The present invention and effects obtained by the present invention are explained in detail referring to Examples. Moreover, the present invention is not limited to the following Examples. The constitution of the present invention can be changed as long as the changes are within the scope of the present invention.

### Example 1

In Example 1, a glass substrate for an HD was set in a vacuum chamber, and then the inside of the vacuum chamber was evacuated to 1.0×10⁻⁵ Pa or less in advance. The glass substrate used was a crystallized glass containing Li₂Si₂O₅, Al₂O₃—K₂O, Al₂O₃—K₂O, MgO—P₂O₅, and Sb₂O₃—ZnO. The outer diameter was 65 mm, the inner diameter was 20 mm, and the average surface roughness (Ra) was 2 Å (0.2 nm).

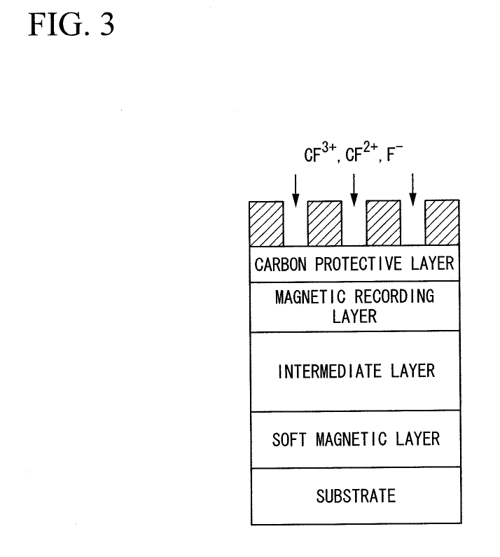

Then, as shown in FIG. 3, a FeCoB alloy layer as the soft magnetic layer, a Ru layer as the intermediate layer, and a 70Co-5Cr-15Pt-10SiO₂ alloy layer as the recording magnetic layer was laminated on the glass substrate using a DC sputtering method. After that, the carbon protective layer was further laminated using P-CVD method. The thickness of the FeCoB soft magnetic layer, the Ru intermediate layer, the magnetic layer, and the carbon protective layer was about 600 Å, 100 Å, 150 Å, and 4 nm respectively.

After that, a UV hardening resin was coated on the surface of the obtained laminate such that the thickness thereof was 200 nm. Then, the imprint was carried out on the UV hardening resin on the carbon protective layer using a Ni stamp. The Ni stamp had a pattern having a track pitch of 100 nm and a depth of groove forming the track pitch of 20 nm.

Then, the surface of the substrate was irradiated with a reactive plasma to improve the magnetic layer where the UV hardening resin did not cover. Inductively Coupled Plasma device NE 550, Marketed by ULVAC Inc. was used to irradiate the reactive plasma. The conditions of irradiating the reactive plasma were: CF₄ (50 cc/min) was used as a gas for generating the plasma, the injection power was 800 W, the inside pressure was 1.2 Pa, and the substrate bias was 300 W, and the treatment was performed to irradiate the reactive plasma on the surface of the magnetic recording medium for 60 seconds.

Moreover, the treatment conditions were selected such that the amount of CF³⁺, CF², and F⁻ in the plasma by plasma optical emission was as large as possible.

Then, the resist on the surface of the substrate was removed by dry etching, and the carbon protective layer was formed thereon. After that, a fluorine lubricant was coated on the surface of the obtained laminate. Thereby, the magnetic recording medium was produced in Example 1.

### Comparative Example 1

The comparative magnetic recording medium was produced in a manner identical to that of Example 1, except that CF₄ (10 cc/min) and O₂ (90 cc/min) were used as a gas for generating the plasma, the injection power was 200 W, the inside pressure was 0.5 Pa, and the substrate bias was 200 W.

The amount of the halogen in the carbon protective layer, the amount of decreased magnetization, the amount of decreased coercive force, the electromagnetic conversion properties (SNR and 3T-squash), and the corrosion resistance were examined in the obtained magnetic recording medium in Example 1 and Comparative Example 1. The results are shown below.

Moreover, the evaluation of the electromagnetic conversion properties were carried out using a spin stand. In addition, a perpendicular recording head was used to record, and a TuMR head was used to reproduce. Then, SNR and 3T-squash were examined when a 750 kFCI signal was recorded.

In the corrosion resistance test, a 3%-nitric acid aqueous solution (100 μL/point) was added dropwise on five points on the surface of the magnetic recording medium, and pure water (100 μL/point) was also added dropwise on five points. Then, this was left to rest for one hour. The amount of Co in the solution and pure water was examined using ICP-MS.

### (Evaluation Results in Example 1)

| | |
|---|---|
| Amount of the halogen in the carbon protective layer: | 15 atomic % |
| Percentage of the magnetization after the reactive | 18% |
| plasma treatment relative to the magnetization | |
| before treatment: | |
| Percentage of the coercive force after the reactive | 32% |
| plasma treatment relative to the coercive force | |
| before the treatment: | |
| SNR: | 13.0 dB |
| 3T-squash: | 81% |
| Result of the corrosion resistance test | 100 counts |

### (Evaluation Results in Comparative Example 1)

| | |
|---|---|
| Amount of the halogen in the carbon protective layer: | 0 atomic % |
| Percentage of the magnetization after the reactive | 21% |
| plasma treatment relative to the magnetization | |
| before treatment: | |
| Percentage of the coercive force after the reactive | 35% |
| plasma treatment relative to the coercive force | |
| before the treatment: | |
| SNR: | 12.6 dB |
| 3T-squash: | 79% |
| Result of the corrosion resistance test | 350 counts |

It is clear from the evaluation results that the magnetic recording medium obtained in Example 1 has superior properties to those of the magnetic recording medium obtained in Comparative Example 1.

1. A method for producing a magnetic recording medium having a magnetic recording pattern which is magnetically separated, comprising the steps of: after laminating at least a magnetic layer and a carbon protective layer on a non-magnetic substrate in this order, partially irradiating with a reactive plasma containing carbon and a halogen or reactive ions which are generated in the reactive plasma on a surface of the carbon protective layer, and thereby forming a halogenated carbon protective layer, which is obtained by partially halogenating the carbon protective layer, and the magnetic recording pattern magnetically separated, which is obtained by partially improving the magnetic layer.

2. The method for producing a magnetic recording medium according to claim 1, wherein a magnetization amount of an improved part of the magnetic layer is 75% or less relative to a magnetization amount of the magnetic layer before improvement.

3. The method for producing a magnetic recording medium according to claim 1, wherein the reactive ions contain carbon and a halogen ion which is obtained by introducing at least one halogenated gas selected from the group of CF₄, CF₆, CHF₃, and CCl₄, into the reactive plasma.

4. The method for producing a magnetic recording medium according to claim 3, wherein the reactive ions are at least one of CF³⁺, CF²⁺, and F⁻.

5. The method for producing a magnetic recording medium according to claim 1, wherein after forming the carbon protective layer, a mask layer is further formed on the carbon protective layer, and the carbon protective layer, where the mask layer is not formed, is partially irradiated with the reactive plasma including carbon and a halogen or the reactive ions which are generated in the reactive plasma.

6. The method for producing a magnetic recording medium according to claim 1, wherein the magnetic recording pattern is a perpendicular magnetic recording pattern.

7. A magnetic recording and reproducing device comprising:
the magnetic recording medium produced by the production method according to claim 1;
a driving part for driving the magnetic recording medium in a recording direction;
a magnetic head for recording and reproducing the magnetic recording medium;
a head shifting device for relatively shifting the magnetic head to the magnetic recording medium; and
a recording and reproducing signal processing device for inputting a signal to the magnetic head and reproducing an output signal from the magnetic head.

8. A magnetic recording medium comprising a magnetic layer and a carbon protective layer on a non-magnetic substrate in this order, a halogenated carbon protective layer which is obtained by partially halogenating the carbon protective layer, and a magnetic recording pattern which is obtained by partially improving the magnetic layer to be magnetically separated.

9. The magnetic recording medium according to claim 8, wherein the halogenated carbon protective layer and the improved magnetic layer are continuously formed in a thickness direction thereof.
